(19) United States
(12) Patent Application Publication
(10) Pub. No.: US 2010/0040732 A1
(43) Pub. Date: Feb. 18, 2010

(54) Compositions and Methods for Fermented Nutraceuticals

(75) Inventors: Jeff Van Drunen, South Holland, IL (US); John Hunter, South Holland, IL (US)

Correspondence Address: FISH & ASSOCIATES, PC;ROBERT D. FISH, 2603 Main Street, Suite 1000, Irvine, CA, 92614-6232, US

(73) Assignees: VDF FUTURECEUTICALS, INC., Momence, IL (US); NEW CHAPTER, INC., Brattleboro, VT (US)

(21) Appl. No.: 12/193,242

(22) Filed: Aug. 18, 2008

(51) Int. Cl. A23C 9/13; A23L 1/48

(52) U.S. Cl. 426/18; 426/7; 426/42; 426/60; 426/61

(57) ABSTRACT

Nutritional products are prepared using a dual fermentation process in which distinct and separate botanical fermentation and probiotic fermentation steps increase nutritional value and/or quality of a vitamin or other nutritionally relevant compound. Alternatively, both fermentation steps could also be combined. Most preferably, a nutritionally desirable carrier such as cow milk, soy milk, or rice milk is used as fermentation medium, which is then subjected to a botanical fermentation with a sprout extract and a probiotic fermentation with a lactobacillus culture. It is further preferred that at least one of the fermentation steps is performed in the presence of the vitamin or other nutritionally relevant compound.

### FIELD OF THE INVENTION

The field of the invention is compositions and methods for nutritional supplements, and especially those obtained by dual fermentation processes.

### BACKGROUND OF THE INVENTION

Fermentation of food has been employed for millennia to convert numerous nutrients and other substrates into desirable products. For example, fermentation can be used to produce desirable end products from a base material (e.g., milk into various dairy products, carbohydrates into ethanol), or can be used to form side products as an aid in obtaining a desired product parameter (e.g., CO₂ production to aerate dough). In still further known examples, fermentation is employed to produce large quantities of one or more specific desired microorganisms, typically for use in a probiotic supplement (e.g., Bifidobacterium breve in soymilk as described in EP 1010753 B1, or numerous Lactobacillus species).

Additionally known uses of fermentation include those in which one or more known compounds are rendered more active, bioavailable, or otherwise beneficial. For example, dual microbial fermentation using bacterial and yeast cultures for various ingredients as described in U.S. Pat. Nos. 6,806,069 and 6,867,024 (fermentation of CoQ10 preparation to stabilize CoQ10 in a glycoprotein matrix) or U.S. Pat. No. 6,797,287 (phaseolamine/mineral preparation bound in a glycoprotein matrix formed by the microorganisms). Such dual microbial fermentation may be further assisted by proteolytic digest of the first microbial culture to increase the amount of glycoprotein matrix as described in U.S. Pat. No. 6,864,231 for mineral containing preparations, and U.S. Pat. No. 6,942,856 and U.S. Pat. App. No. 2005/048125 for various vitamin containing preparations. While such preparations will provide at least some advantages, various drawbacks nevertheless remain. For example, the medium for the dual microbial fermentation must be carefully chosen to promote growth for both microbial strains. Moreover, use of yeast is not always desirable from a marketing as well as tolerability perspective.

Thus, while many configurations and methods for fermented nutraceutical compositions are known in the art, all or almost all of them, suffer from one or more disadvantages. Therefore, there is still a need for improved compositions and methods of fermented nutraceutical compositions.

### SUMMARY OF THE INVENTION

The present invention is directed to compositions and methods of producing a fermented nutraceutical composition in which a nutritionally acceptable fermentation medium is subjected to a botanical fermentation (fermentation with an enzymatically active plant preparation) and a probiotic fermentation (fermentation with one or more probiotic microorganism), and in which the composition comprises an added nutritional compound in an amount effective to deliver in a single dosage unit at least 10% of the RDA (recommended daily allowance) for the nutritional compound.

In an especially preferred aspect of the inventive subject matter, a method of producing a fermented nutraceutical composition includes a step of providing a liquid probiotic fermentation medium and a further step of fermenting the fermentation medium in a first fermentation reaction with one of an enzymatically active plant preparation and a probiotic culture to thereby produce a primary medium. The primary medium is then fermented in a second fermentation reaction with another of the enzymatically active plant preparation and the probiotic culture to thereby produce a secondary medium, and an at least partially purified nutritional compound is added to at least one of the probiotic fermentation medium and the primary medium, wherein the compound is most preferably added in an amount sufficient to deliver at least 10% of a recommended daily allowance for the nutritional compound in a dosage unit produced from the secondary medium.

It should further be especially appreciated that the step of fermenting the primary medium is performed with the enzymatically active plant preparation when the step of fermenting the fermentation medium is performed with the probiotic culture or wherein the step of fermenting the primary medium is performed with the probiotic culture when the step of fermenting the fermentation medium is performed with the enzymatically active plant preparation. Thus, it should be recognized that the fermented nutraceutical composition has undergone two different and distinct fermentation steps wherein one step employs fermentation with an enzymatically active plant preparation while the other step employs fermentation with a probiotic culture.

Most preferably, the liquid probiotic fermentation medium comprises a nutritionally acceptable plant preparation (e.g., soy milk, rice milk, or almond milk) or a dairy preparation (e.g., milk or yoghurt), and the first fermentation reaction is performed with the enzymatically active plant preparation while the second fermentation reaction is performed with the probiotic culture. In further preferred aspects, the fermentation reaction with the enzymatically active plant preparation is performed for between 1 and 24 hours and the fermentation reaction with the probiotic culture is performed for between 4 and 48 hours.

Particularly contemplated enzymatically active plant preparations will comprise a sprout preparation, a fruit preparation, and/or a preparation of a non-green portion of a plant, and preferred probiotic cultures will comprise at least one of a nutritionally acceptable bacterial culture (e.g., Lactobacillus spec. or Bifidobacterium spec.) and a nutritionally acceptable yeast culture (e.g., Saccharomyces spec.). With respect to the added partially purified nutritional compound it is generally preferred that the compound is a vitamin, mineral and/or otherwise beneficial and partially enriched ingredient. Where desired, water may be removed from the secondary medium to thereby form an at least partially dehydrated preparation, which may be formulated a tablet, capsule, powder, or together with another edible carrier (e.g., snack bar or liquid carrier).

Therefore, in a still further aspect of the inventive subject matter, nutritional supplements produced by the methods presented herein are contemplated, and especially preferred nutritional supplements will be formulated as a snack bar, drink, tablet, or capsule and include a vitamin and/or mineral as added nutritional compound. As above, it is generally preferred that the liquid probiotic fermentation medium comprises a nutritionally acceptable plant preparation or a dairy preparation.

Various objects, features, aspects and advantages of the present invention will become more apparent from the following detailed description of preferred embodiments of the invention.

### DETAILED DESCRIPTION

The inventors have discovered that dual fermentation of nutritionally acceptable media to generate a nutritional supplement is particularly advantageous when one of the fermentation steps includes a botanical fermentation that is complemented by a probiotic fermentation. In most of the preferred aspects, the medium will include an added nutritionally desirable ingredient at a concentration effective to deliver at least 10% of a recommended daily allowance (RDA) for the nutritionally desirable ingredient in a single dosage unit produced from the medium after the fermentation has been terminated or concluded.

For example, in one aspect of the inventive subject matter, a fermented nutraceutical composition can be prepared using a liquid probiotic fermentation medium that is fermented in a first fermentation reaction with one of an enzymatically active plant preparation and a probiotic culture to form a primary medium that is then fermented in a second fermentation reaction with the other of the enzymatically active plant preparation and the probiotic culture to thereby form a secondary medium. Most preferably, an at least partially purified nutritional compound is added to the liquid probiotic fermentation medium and/or the primary medium, typically in an amount sufficient to deliver at least 10% of a recommended daily allowance for the nutritional compound in a dosage unit produced from the secondary medium.

As used herein, the term “enzymatically active plant preparation” refers to a preparation from one or more plants or portion thereof (e.g., root, fruit, seed, leaf, stem, sprout, hypocotyl, etc.) that comprises a plurality of different enzymes with catalytic activity, where the preparation is chemically heterogeneous (i.e., no single enzyme is present in an amount of at least 10 wt %), and most preferably identical or near identical with respect to the composition of the plant from which the preparation is derived. For example, particularly preferred enzymatically active plant preparations include macerated, juiced, pressed, or otherwise comminuted plant material, which may be filtered and/or dehydrated under a protocol that at least partially retains enzymatic activity. Alternatively, or additionally, suitable enzymatically active plant preparations may also include plant extracts, and especially those in which plant material was first disintegrated and then extracted with a suitable solvent. Most typically, suitable solvents are nutritionally acceptable solvents that will not entirely abrogate enzymatic activity. As above, such extracts may be further filtered and/or dehydrated.

As further used herein, the term “nutritional compound” refers to a compound that is being consumed as part of a usual diet but that is demonstrated to (a) have physiological benefits, (b) ameliorate or alleviate signs and/or symptoms of an acute disease, and/or (c) reduce the risk and/or severity of chronic disease. For example, nutritional compounds include hydrophilic and lipophilic vitamins, numerous carbohydrates (and especially monosaccharides, disaccharides, and dietary soluble and insoluble fibers), minerals, compounds that enhance or modulate metabolism and/or hormonal homeostasis, etc. Therefore, the term “nutraceutical” in conjunction with a compound, composition, or preparation as used herein refers to a compound, composition, or preparation that includes the nutritional compound.

As still further used herein, the term “probiotic culture” refers to a nutritionally acceptable culture of microorganisms that when administered in adequate amounts confer a health benefit on the host. For example, contemplated health benefits include normalization of the intestinal flora, stimulation or normalization of immune responses, and relief of chronic constipation. It should be noted that the term probiotic culture includes live cells, spores or otherwise dormant stages, as well as non-viable cells and cell fragments.

The terms “recommended daily allowance” and “RDA” with respect to a nutritional compound are used interchangeably herein and refer to the average daily dietary intake level of the compound that is sufficient to meet the nutrient requirement of nearly all (97 to 98 percent) healthy individuals in a particular life stage and gender group. Exemplary RDA values for numerous nutritional compounds are listed in 21 CFR 101 and further RDA values are also published by the Institute of Medicine of the National Academy of Science.

In especially preferred aspects, the liquid probiotic fermentation medium is an aqueous medium and comprises a food item that is commercially available to a retail consumer. Most typically, such food item is in liquid form and may be further modified prior to fermentation where desirable. Among other suitable fermentation media, especially preferred media include a nutritionally acceptable plant preparation and/or a dairy preparation. For example, contemplated nutritionally acceptable plant preparations may comprise unprocessed or partially processed liquids (e.g., fruit or vegetable juice, which may be pasteurized, fortified, or otherwise modified), or plant preparation in which one or more components are extracted from the plant or portion thereof and combined with another nutritionally acceptable carrier (e.g., water). Such examples will include stable emulsions of water with oils, fats, and protein as can be found in soy milk, rice milk, or almond milk. Therefore, contemplated fermentation media may also include buffers, emulsifiers, coloring and/or flavoring agents, and nutritionally acceptable non-water solvents (e.g., various alcohols, oils, etc.).

Similarly, especially preferred dairy preparations include those in which the preparation is milk or is derived from milk, typically via fermentation of the milk product. Consequently, suitable dairy preparations include sour milk, kefir, yoghourt, butter milk, etc, wherein the dairy preparation may be further flavored or otherwise modified (e.g., by addition of one or more nutritionally acceptable ingredients. In less preferred aspects, it is also contemplated that the liquid probiotic fermentation medium may also comprise a chemically defined base medium that is ordinarily used in biotechnological fermentation. For example, suitable base media include those comprising various mineral salts and carbohydrates (for minimal media) and those comprising complex ingredients such as yeast extract, digested casein, etc. (for full media). Regardless of the particular composition, it should be appreciated that the liquid probiotic fermentation medium may be concentrated or diluted (with respect to the corresponding commercially available ingredient) to enrich the medium with respect to a particular ingredient or to compensate for at least partially dehydration in a downstream step. For example, where the liquid probiotic fermentation medium comprises fruit juice, the fruit juice may be concentrated between 1.1 and 5 times (and even more) as compared to unconcentrated fruit juice to increase flavonoid content. Similarly, where the liquid probiotic fermentation medium comprises yoghourt, the yoghourt may be diluted (e.g., with milk or water) between 1.1 and 5 times (and even more) as compared to undiluted yoghourt.

With respect to the enzymatically active plant preparation it is generally preferred that the preparation comprises an at least partially disintegrated portion of a plant, and most preferably a preparation from which the solids (particles having a size suitable for removal by filtration or centrifugation) have been removed. There are numerous manners of preparing an enzymatically active plant preparation, and all manners are deemed suitable so long as the preparation has at least some enzymatic activity. For example, suitable preparation methods comprise maceration, grinding, or otherwise comminuting, pressing, solvent extraction, (e.g., steeping, decocting, blending, etc.), freeze-thaw cycling, sonication, etc., and it should be recognized that the particular method will at least in part depend on the starting material. For example, where the starting material comprises nuts or seeds, suitable methods will include grinding or pressing, while maceration or pressing may be bets suitable for sprouts, leaves or other green portions of a plant. Depending on the starting material, it should also be appreciated that suitable methods for preparing the plant preparation will include addition of a solvent for extraction, salvation, and/or dilution. There are numerous nutritionally acceptable solvents known in the art, and all of them are deemed suitable for use herein. Similarly, it should be noted that the enzymatically active plant preparation need not necessarily be limited to liquid preparations. For example, and where desirable, a plant preparation many be at least partially dehydrated to form a syrup, gel, or dry material (that can be powderized for ease of handling).

Regardless of the manner of manufacture of the plant preparation, it is contemplated that the preparation will retain at least some enzymatic activity, and most typically a combination of multiple enzymatic activities. For example, contemplated enzymatic activities include hydrolase activity, ligase activity, lyase activity, polymerase activity, etc., and the specific activities will depend on the particular plant and plan portion used. For example, where the plant preparation is a sprout or fruit extract, contemplated activities will be a combination of a large variety of activities and typically include glycosidase activity, esterase activity, transferase activity, etc. Therefore, contemplated enzymatic activities will include a combination of at least two, more typically at least five, even more typically at least 10, and most typically at least 100 distinct enzymatic activities. Thus, and viewed from a different perspective, especially contemplated plant preparations will not be significantly enriched in a single type of enzyme and it is preferred that no single enzyme is present in an amount of at least 20 wt%, more typically at least 10 wt%, and most typically at least 5 wt%. Consequently, isolated or highly enriched enzyme preparations (e.g., proteases) are expressly excluded.

Without wishing to be bound by any theory or hypothesis, the inventors contemplate that the presence of a plurality of botanical enzymes is particularly beneficial for not only the probiotic organism and the user ingesting the formulations prepared from contemplated methods, but also desirably modify one or more components of the liquid fermentation medium such that the modified medium has increased tolerability (e.g., via enzymatic reduction of potential nut or soy allergens), digestability (e.g., via enzymatic breakdown of harder-to-digest carbohydrates), and nutritional value due to the presence of several desirable compounds (e.g., sulfurophanes, antioxidants, etc.).

With respect to the quantity of enzymatically active plant preparations in the medium it is generally contemplated that the plant preparation is present in a range of between 0.01 wt % (on dry weight basis) and 50 wt % (on dry weight basis), more typically between 0.1 wt % (on dry weight basis) and 20 wt % (on dry weight basis), and most typically between 0.5 wt % (on dry weight basis) and 5 wt % (on dry weight basis). Similarly, where the enzymatically active plant preparation is a liquid, it is typically preferred that the plant preparation is present in a range of between 0.1% (v/v) and 50% (v/v), more typically between 1% (v/v) and 30% (v/v), and most typically between 5% (v/v) and 20% (v/v). Regardless of the quantity and/or manner of preparation of the enzymatically active plant preparation, it is generally contemplated that the enzymatically active plant preparation will not substantially affect cell viability (i.e., loss of at least 25% of cell viability) or cellular structural integrity (i.e., loss of at least 25% of cell integrity and particularly membrane disintegration).

Depending on the particular medium composition and the amount of enzymatically active plant preparations in the medium it should be recognized that the botanical fermentation may be performed at a relatively wide range of temperatures and time periods. However, it is typically preferred that the botanical fermentation is performed at a temperature of between 15° C. and 45° C. for a period of no longer than 36 hours. Therefore, particularly preferred temperature ranges are between 20° C. and 40° C., and even more preferably between 23° C. and 35° C. Preferred time periods for fermentation include 15 minutes to 4 hours, and more preferably between 30 minutes and 120 minutes. However, and especially where the plant preparation is at a relatively low concentration, the botanical fermentation may also be run for significantly longer time periods (e.g., between 2 hours and 36 hours, and even longer). The enzymatically active plant preparation is preferably added to the medium at the beginning of the fermentation, however, in alternative aspects, the enzymatically active plant preparations may also be added in multiple and distinct doses.

It should further be noted that the botanical fermentation may be terminated by an active step, and especially contemplated active steps include flash pasteurization and/or change of pH (e.g., acidification and subsequent neutralization). Alternatively, the fermentation may also be terminated at the end of the production process, typically via sterilization or dehydration. Therefore, especially where the botanical fermentation precedes the probiotic fermentation, the botanical fermentation may run at least for some time parallel to the probiotic fermentation.

Suitable probiotic cultures will comprise one or more nutritionally acceptable bacterial cultures and/or one or more nutritionally acceptable yeast cultures, and especially preferred probiotic bacterial cultures include various Lactobacillus cultures and/or a Bifidobacterium cultures, and particularly preferred yeast cultures include various Saccharomyces cultures. Thus, and among other suitable strains, particularly suitable probiotics include Bifidobacterium animalis subsp. Lactis, Bifidobacterium bifidum, Bifidobacterium breve, Bifidobacterium infantis, Bifidobacterium longum, Bacillus coagulans, Lactobacillus acidophilus, Lactobacillus casei, Lactobacillus plantarum, Lactobacillus reuteri, Lactobacillus rhamnosus, Lactobacillus GG, Lactobacillus bulgaricus, and Streptococcus thermophilus. Where the probiotic is a probiotic yeast, Saccharomyces boulardii, Saccharomyces cerevisiae, and Saccharomyces bayanus are especially contemplated. Further suitable probiotic strains are described, for example, in WO 02/076471, which is incorporated by reference herein.

Most typically, probiotic fermentation will be performed at an initial cell concentration of between 10³-10⁹ cfu/ml of fermentation medium and may be carried to a desired end point. For example, suitable end points may be time dependent, product dependent, or cell count dependent. For example, in preferred aspects of the inventive subject matter, probiotic fermentation may be performed for a period of between 30 minutes and 6 hours, and more typically between 1 hour and 4 hours. Alternatively, probiotic fermentation may also be terminated once a specific metabolite has reached a predetermined concentration. For example, fermentation may be terminated when complex sugar concentration or selected monosaccharides (e.g., glucose, fructose, mannose, etc.) have dropped to a certain predetermined level. Alternatively, accumulation of lactic acid may be monitored and fermentation may be terminated upon reaching a predetermined concentration. Similarly, a change in pH (e.g., acidification to pH 6.5, pH 6.0, pH 5.0, or even lower) or a desired cell concentration (e.g., between 10⁶-10¹² cfu/ml) may be employed as fermentation endpoint. Depending on the particular fermentation, it should be noted that the second fermentation may be terminated by heating, addition of one or more additives that reduce cell viability (e.g., alcohol, proteinase, etc.). Alternatively, or additionally, fermentation may be terminated by dehydration. In such case, where viable cells are expected to remain in the medium, probiotic ingredients (i.e., ingredients promoting growth of probiotic organisms) may be added to assist in recovery of the dehydrated cells.

With respect to contemplated nutritional compounds it is contemplated that all known nutritional compounds are deemed suitable for use herein, and that the compositions presented herein may include one or more of the nutritional compounds that were added to the medium in an at least partially purified form (i.e., at least 10% purity). For example, especially contemplated nutritional compounds include lipophilic vitamins A, D, E, and K, hydrophilic vitamins C, B1, B6, B12, cofactors including CoQ10, minerals, and especially calcium, magnesium, boron, zinc, iron, chromium, potassium, lithium, selenium, and iodine (all of which are preferably present in ionic form). Similarly, suitable compounds involved in modulation of metabolism (anabolic as well as catabolic) include DHEA, amino acids, forskolin, vinpocetine, etc., and various fatty acids, glucosamine, chondroitin, etc. Depending on the type of preparation and source, suitable nutritional compounds may be added as crude preparation having a purity of between 10-30%, as more purified preparation having a purity of between 30-85%, and as purified preparation having a purity of between 85-95%, or even higher.

Regardless of the source and purity, it is preferred that the nutritional compound is added in an amount sufficient to deliver at least 10% of the RDA for the nutritional compound in a dosage unit that is produced from the fermentation medium (most typically from the secondary medium). However, in more preferred aspects, the nutritional compound is added in an amount sufficient to deliver at least 25%, even more preferably at least 50%, and most preferably at least 80-100% of the RDA for the nutritional compound. Therefore, it should be appreciated that the fermentation medium is relatively concentrated with respect to the nutritional compound.

Most typically, the nutritional compound is added to the fermentation medium prior to the first (e.g., botanical) fermentation and one or more further nutritional compounds may be added at a later point in time, most commonly prior to the second (e.g., probiotic) fermentation. However, in alternative aspects, one or more of the nutritional compounds may be added to the medium during the first and/or second fermentation and in some cases even after the second fermentation has concluded. Therefore, addition of the nutritional compound may be performed in batch mode or in a continuous manner.

Once the last (typically second) fermentation has concluded, it should be appreciated that the so produced secondary fermentation medium may be directly employed for further use. For example, the secondary fermentation medium may be bottled or encapsulated, or may be added to a nutritionally acceptable carrier. Such addition may be mixing with a fluid carrier, or mixing with a solid (preferably absorbent) or powdered carrier, wherein such admixture may be done by intermingling, dipping, or spray-coating. However, in even more preferred aspects of the inventive subject matter, it is contemplated that at least some of the water is removed from the secondary medium to thereby form an at least partially dehydrated preparation.

Most preferably, the secondary medium is dehydrated to a residual water content of less than 15 wt %, more typically less than 10 wt %, and most typically less than 5 wt %. Alternatively, and especially where the residual water content is greater than 5 wt %, additional agents may be included that reduce water activity to a value of equal or less than 0.75, more preferably 0.7, and most preferably 0.65. There are numerous methods and processes of dehydration of food items known in the art, and all of them are suitable for use in conjunction with the teachings herein. However, especially preferred dehydration methods include spray-drying, freeze-drying, drum-drying, and air-drying.

In further especially preferred aspects, the secondary medium is formulated as a tablet, a capsule, or powder suitable for oral administration. For example, the secondary medium may be formulated into a tablet with enteric coating, or pressed into a tablet together with nutritionally acceptable ingredients (e.g., disintegrants, flavoring agents, food color, etc.). Alternatively, the secondary medium may also be combined with a complex nutritionally acceptable carrier to so form a nutritionally enhanced food item that can then be further processed or packaged. For example, suitable complex carrier formulations include fluor, bread dough, breakfast cereals, snack bars, ready-to-eat meals, and drinks (e.g., soft drink, soy milk, etc.). Consequently, many dietary items, and especially nutritional supplements are contemplated and especially include snack bars, drinks, tablets, and capsules that include at least one of a mineral and a vitamin at a dosage of at least 10% of RDA for the specific mineral and/or vitamin. As provided above, the nutritional supplement may be in solid or liquid form and will be prepared using a liquid or at least partially dehydrated probiotic fermentation medium, most preferably comprising a nutritionally acceptable plant and/or dairy preparation. Therefore, in at least some of the embodiments of the inventive subject matter, the first fermentation reaction is performed with the enzymatically active plant preparation (preferably for a period of between 1 and 24 hours) and the second fermentation reaction is performed with the probiotic culture (preferably for a period of between 4 and 48 hours).

### EXAMPLES

The following examples are provided to give exemplary guidance on how to make and use contemplated dual fermentation processes and compositions. It should be noted, however, that numerous modifications are possible without departing from the inventive concept presented herein.

### Minimal Medium Fermentation Base

There are numerous defined minimal aqueous fermentation media for propagation of probiotic organisms known in the art, and all known media are deemed suitable for use herein. For example, suitable minimal media will typically provide a carbon source (most commonly saccharides or glycols), one or more nitrogen sources (typically in form of amino acids, but ammonium salts are also appropriate), various vitamins and cofactors, and minerals as described elsewhere (e.g., J Bacteriol. 1981;148:64-71, or Applied and Environmental Microbiology, December 2000, p. 5306-5311, Vol. 66, No. 12., both incorporated by reference herein)

### Complex Defined Fermentation Base

There are numerous complex defined aqueous fermentation media for propagation of probiotic organisms known in the art, and all known media are deemed suitable for use herein. For example, various Lactobacillus strains can be grown in a defined complex medium (Applied and Environmental Microbiology, December 2005, p. 8165-8173, Vol. 71, No. 12, incorporated by reference herein) comprising 1.00 wt % Variolac 836 (Whey permeate powder comprising lactose and proteins; MD Foods Ingredients, Denmark), 0. 10 wt % Tween 80 (Quest International, The Netherlands), 1.00 wt % Pisane (Pea protein concentrate; Cosucra, France), 3.00 wt % yeast extract 2012 (Biospringer, France), 1.00 wt % Primatone RL (Enzymatic digest of meat high in amino acids and peptides; Quest International, The Netherlands), and optionally containing 0.75 wt % sucrose (Fluka, Switzerland) and 0.75 wt % fructose (Fluka, Switzerland). The pH is typically adjusted to a range of between 7.5 and 4.0.

### Complex Plant Fermentation Base

Similarly, there are numerous complex aqueous plant fermentation media for propagation of probiotic organisms known in the art, and all known media are deemed suitable for use herein. Among other suitable choices, the plant base may be founded on soy, typically comprising soy peptone (typically between 1-5 wt %), maltodextrin (typically between 0.5-3 wt %), maize starch (typically between 0.1 -2 wt%), and soymilk (typically between 5-95 wt %). Still further suitable ingredients include mineral compositions as described in the above bases. Once more, the pH is typically adjusted to a range of between 7.5 and 4.0. Of course, it should be noted that the plant base may also be founded on other plant materials, and especially suitable materials include rice, and various nuts (and especially almonds), which are most preferably added in form of the corresponding milk (e.g., rice milk, almond milk, etc.).

### Complex Dairy Fermentation Base

It should still further be appreciated that while plant or defined fermentation bases are typically preferred, fermentation base materials other than plant derived bases are also considered suitable for use herein. For example, particularly preferred alternative bases may also be founded on various dairy products, and especially preferred dairy products include milk, yoghourt, kefir, and buttermilk. These alternative fermentation bases may comprise a significant proportion (e.g., greater 20 wt %) of the dairy product, and may further be fortified with one or more media components of the above media. Most typically, the pH of such bases will be in the range of 3.0 to 6.5.

### Botanical Fermentation

It is generally preferred that the botanical fermentation is performed in a fermentation base of choice prior to the probiotic fermentation, and that the medium is carried over from the botanical fermentation into the probiotic fermentation. Typically, the botanical fermentation is performed for a period of between 30 minutes and 6 hours, more typically between 1 hour and 4 hours, and most typically for about 2 hours (+/−30 minutes). With respect to suitable temperatures, it is contemplated that the botanical fermentation is run at between 60° F. and 110° F., more typically between 70° F. and 100° F., and most typically at about 90° F. (+/−5° F.).

In particularly preferred aspects, the botanical fermentation employs a sprout extract (e.g., optionally freeze-dried sprout preparation from macerated and filtered sprouts). For example, botanical fermentation may be performed for 2 hours at 90° F. using broccoli and/or cauliflower enzymatically active sprout preparations (e.g., optionally freeze-dried sprout preparation from mazerated and filtered sprouts). Most typically, the enzymatically active plant preparation is present in an amount of between 0.1 wt % and 20 wt % (although higher and lower amounts are not excluded).

### Addition of Least Partially Purified Nutritional Compounds

Once the botanical fermentation has concluded, one or more desired vitamins, minerals, cofactors, or other beneficial compounds are added in an amount to make up about 100% RDA of the vitamins, minerals, cofactors, or other beneficial compound in the final product. It should be recognized, however, that such addition need not be limited to a time after the botanical fermentation has concluded. For example, the vitamins, minerals, cofactors, or other beneficial compound may be added prior to or after the start of the botanical fermentation.

### Probiotic Fermentation

After addition of the nutritional compound and/or after conclusion of the botanical fermentation, one or more strains of probiotic organisms are added for the probiotic fermentation. For example, the medium from the botanical fermentation is inoculated one or more of L. Acidophilus, L. Rhamnosus, S. Thermophilus, and Saachromyces cerevisiae to an initial concentration of 10E3 to 10E6 cfu/ml. Fermentation is then carried out at between 90° F. and 115° F., more typically between 95° F. and 110° F., and most typically at about 104° F. Under most circumstances, probiotic fermentation is carried out for between 1 hour and 48 hours, more typically between 6 hours and 24 hours, and most typically between 10-14 hours.

### Deactivation Steps

Where desired, the fermentation may be concluded with one or more process steps in which the microorganisms (bacterial and/or yeast) are inactivated. Such inactivation is most preferably performed using physical and/or chemical process steps. For example, suitable physical deactivation steps include sonication, pressurization followed by rapid depressurization (French press), radiation, and/or heat treatment (e.g., pasteurization), while appropriate chemical process steps especially include enzymatic deactivation.

In especially preferred aspects, the probiotic fermentation is concluded by addition of a nutritionally acceptable proteolytic enzyme (e.g., papain, bromelain, etc.) for a duration sufficient to reduce viable cell count at least 99% and more typically at least 99.9%. For example, protease treatment with papain for about 2 hours (e.g., +/−30 minutes) at a temperature of between about 70-90° F. The so treated medium may then be further heat inactivated for relatively short time, typically between 5 and 30 minutes at a temperature of between about 150-200° F. (e.g., 170° F. for 15 minutes).

Depending on the particular further use, the so prepared mixture may then be directly used in a product combination, bottled or otherwise packaged, or at least partially dehydrated to produce a syrup or dry matter. In one preferred aspect, the mixture is spray dried at 160° F. for a few seconds and the dried product is then screened, milled, filtered, and packaged.

Thus, specific embodiments and applications of fermented nutraceuticals have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Furthermore, where a definition or use of a term in a reference, which is incorporated by reference herein is inconsistent or contrary to the definition of that term provided herein, the definition of that term provided herein applies and the definition of that term in the reference does not apply.

What is claimed is:

1. A method of producing a fermented nutraceutical composition, comprising:
providing a liquid probiotic fermentation medium;
fermenting the fermentation medium in a first fermentation reaction with one of an enzymatically active plant preparation and a probiotic culture to thereby produce a primary medium;
fermenting the primary medium in a second fermentation reaction with another of the enzymatically active plant preparation and the probiotic culture to thereby produce a secondary medium;
wherein the step of fermenting the primary medium is performed with the enzymatically active plant preparation when the step of fermenting the fermentation medium is performed with the probiotic culture or wherein the step of fermenting the primary medium is performed with the probiotic culture when the step of fermenting the fermentation medium is performed with the enzymatically active plant preparation;
adding an at least partially purified nutritional compound to at least one of the probiotic fermentation medium and the primary medium; and
wherein the nutritional compound is added in an amount sufficient to deliver at least 10% of a recommended daily allowance for the nutritional compound in a dosage unit produced from the secondary medium.

2. The method of claim 1 wherein the liquid probiotic fermentation medium comprises a nutritionally acceptable plant preparation or a dairy preparation.

3. The method of claim 2 wherein the nutritionally acceptable plant preparation comprises a soy preparation, a rice preparation, or a nut preparation.

4. The method of claim 2 wherein the dairy preparation comprises milk or a fermented milk preparation.

5. The method of claim 1 wherein the first fermentation reaction is performed with the enzymatically active plant preparation and wherein the second fermentation reaction is performed with the probiotic culture.

6. The method of claim 1 wherein the fermentation reaction with the enzymatically active plant preparation is performed for between 1 and 24 hours.

7. The method of claim 1 wherein the fermentation reaction with the probiotic culture is performed for between 4 and 48 hours.

8. The method of claim 1 wherein the enzymatically active plant preparation comprises a sprout preparation, a fruit preparation, or a preparation of a non-green portion of a plant.

9. The method of claim 1 wherein the probiotic culture comprises at least one of a nutritionally acceptable bacterial culture and a nutritionally acceptable yeast culture.

10. The method of claim 9 wherein the probiotic culture comprises at least one of a lactobacillus culture, a Bifidobacterium culture, and a Saccharomyces culture.

11. The method of claim 1 wherein the partially purified nutritional compound comprises a vitamin.

12. The method of claim 1 wherein the partially purified nutritional compound comprises a mineral.

13. The method of claim 1 further comprising a step of removing water from the secondary medium to thereby form an at least partially dehydrated preparation.

14. The method of claim 13 wherein the at least partially dehydrated preparation is formulated as a tablet, capsule, or powder.

15. The method of claim 1 further comprising a step of combining the secondary medium with a nutritionally acceptable carrier.

16. The method of claim 15 wherein the nutritionally acceptable carrier is a snack bar or a drink.

17. A nutritional supplement produced by the method of claim 1.

18. The nutritional supplement of claim 17 formulated as a snack bar, drink, tablet, or capsule.

19. The nutritional supplement of claim 17 wherein the nutritional compound is at least one of a vitamin and a mineral.

20. The nutritional supplement of claim 17 wherein the liquid probiotic fermentation medium comprises a nutritionally acceptable plant preparation or a dairy preparation.
